(19) United States
(12) Patent Application Publication
(10) Pub. No.: US 2020/0396691 A1
(43) Pub. Date: Dec. 17, 2020

(54) Transmit Power Control in a Wireless Communications Network

(71) Applicant: Telefonaktiebolaget LM Ericsson (publ), Stockholm (SE)

(72) Inventor: Niklas Wernersson, Kungsängen (SE)

(21) Appl. No.: 16/644,710

(22) PCT Filed: Aug. 30, 2018
(86) PCT No.: PCT/EP2018/073334

§ 371 Date: Mar. 5, 2020

Related U.S. Application Data
(60) Provisional application No. 62/556,751, filed on Sep. 11, 2017.

(51) Int. Cl. H04W 52/08; H04W 52/14; H04W 52/24; H04W 52/54; H04W 52/58; H04W 24/10; H04W 52/32; H04L 25/02

(52) U.S. Cl. CPC H04W 52/08; H04W 52/146; H04W 52/242; H04L 25/0226; H04W 52/58; H04W 24/10; H04W 52/325; H04W 52/545

(57) ABSTRACT

A method performed by a wireless device for transmit power control, the wireless device being operable in a wireless telecommunications network, the wireless device being configured to determine a value for its transmit power based at least in part on cumulative transmit power control, whereby the wireless device determines a value for a cumulative transmit power control function based on a previous value for the cumulative transmit power control function and a correction value. The method comprises receiving, from a network node operable in the wireless telecommunications network, a control signal comprising an indication of a correction value, wherein the indication of the correction value has one of a plurality of possible values. The method further comprises responsive to a determination that the indication of the correction value is a particular value of the plurality of possible values, resetting the cumulative transmit power control. There is also provided a method performed by a network node, a wireless device and a network node such as a base station.

### TECHNICAL FIELD

This disclosure relates to a method performed by a wireless device for transmit power control, a method performed by a network node, a wireless device and a network node.

### BACKGROUND

### Power Control

Setting output power levels of transmitters, base stations in downlink and mobile stations in uplink, in mobile systems is commonly referred to as power control (PC). Objectives of PC include improved capacity, coverage, improved system robustness, and reduced power consumption.

In LTE PC mechanisms can be categorized into the groups (i) open-loop, (ii) closed-loop, and (iii) combined open- and closed-loop. These differ in what input is used to determine the transmit power. In the open-loop case, the transmitter measures some signal sent from the receiver, and sets its output power based on this. In the closed-loop case, the receiver measures the signal from the transmitter, and based on this sends a Transmit Power Control (TPC) command to the transmitter, which then sets its transmit power accordingly. In a combined open- and closed-loop scheme, both inputs are used to set the transmit power.

In systems with multiple channels between the terminals and the base stations, e.g. traffic and control channels, different power control principles may be applied to the different channels. Using different principles yields more freedom in adapting the power control principle to the needs of individual channels. The drawback is increased complexity of maintaining several principles.

### PC Loops

In, for instance LTE release 10, the UE initially performs PC for PRACH using

P_{PRACH}=min{P_{CMAX,c}(i),PREAMBLE_RECEIVED_TARGET_POWER+PL_{c}}.

After a connection is established between the UE and the eNodeB the UE can be configured for performing UL PC also on PUCCH, PDSCH and SRS transmission. Setting the UE transmit power for a physical uplink control channel (PUCCH) transmission is done from

P_{PUCCH}=min{P_{CMAX,c},P_{0,PUCCH}+PL_{c}+∇_{Format}+g(i)}

Here P_{PUCCH} is the transmit power to use in a given subframe and PL_{c} is the pathloss estimated by the UE. For PUSCH one instead uses the equation

P_{PUSCH,c}=min{P_{CMAX,c}−P_{PUCCH},P_{0,PUSCH}+αPL_{c}+10 log₁₀M+∇_{MCS}+f(i)}

where c denotes the serving cell and P_{PUSCH,c} is the transmit power to use in a given subframe. For SRS one defines

P_{SRS,c}(i)=min{P_{CMAX,c}(i),P_{SRS_OFFSET,c}(m)+10 log₁₀(M_{SRS,c})+P_{O_PUSCH,c}(j)+α_{c}(j)·PL_{c}+f_{c}(i)}.

Also here we note that PL_{c} is a part of setting the power level for the UE transmission which corresponds to the open loop part of power control. It is clear from this that the pathloss estimation conducted by the UE may play an important role in the PC. The pathloss may in turn be estimated from a DL transmission and is typically done by measurement on a reference signal (e.g. SRS).

### Closed Loop Power Control

In the above power control formulas there were two terms f(i) and go) defined which correspond to the closed loop part of the power control. These terms are controlled by signaling from the gNB using TPC (Transmission Power Control) command (over MAC CE or DCI). By using this the gNB will be able to impact the UE output power which is useful in order to for instance
combat estimation errors impacting the UL PC
get rid of biases
adopt the UE output power to the current interference level at the gNB. If the interference is high it may be motivated to increase the UE output power.

There are different ways to configure the operation of f(i). It can operate in “accumulated mode” or “absolute mode”. In case accumulation is enabled, for instance based on the parameter Accumulation-enabled provided by higher layers, f(i) is given from f_{c}(i)=f_{c}(i−1)+δ_{PUSCH,c}(i−K_{PUSCH}) where δ_{PUSCH,c} is a correction value, also referred to as a TPC command, and can take on values according to the tables below (see TS 36.213, v10.13.0 for more details). Furthermore. the UE shall reset accumulation
For serving cell c, when P_{O_UE_PUSCH,c} value is changed by higher layers
For the primary cell, when the UE receives random access response message

TABLE 5.1.1.1-2
Mapping of TPC Command Field in DCI
format 0/3/4 to absolute and accumulated

| TPC Command Field in | Accumulated | Absolute δ_{PUSCH, c} [dB] only |
|---|---|---|
| DCI format 0/3/4 | δ_{PUSCH, c} [dB] | DCI format 0/4 |
| 0 | −1 | −4 |
| 1 | 0 | −1 |
| 2 | 1 | 1 |
| 3 | 3 | 4 |

TABLE 5.1.1.1-3

| Mapping of TPC Command Field in DCI | |
|---|---|
| format 3A to accumulated δ_{PUSCH, c} values. | |
| TPC Command Field in | |
| DCI format 3A | Accumulated δ_{PUSCH, c} [dB] |
| 0 | −1 |
| 1 | 1 |

The functionality of g(i) is similar and defined from

$$g ( i ) = g ( i - 1 ) + {\sum }_{m = 0}^{M - 1} {δ}_{P U C C H} ( i - {k}_{m} )$$

where g(i) is the current PUCCH power control adjustment state and where g(0) is the first value after reset. The UE shall reset accumulation
P when P_{O_UE_PUCCH} value is changed by higher layers
when the UE receives a random access response message
   and δ_{PUCCH} is given by the tables below.

TABLE 5.1.2.1-1

| Mapping of TPC Command Field in DCI format | |
|---|---|
| 1A/1B/1D/1/2A/2B/2C/2/3 to δ_{PUCCH} values. | |
| TPC Command Field | |
| in DCI format | |
| 1A/1B/1D/1/2A/2B/2C/2/3 | δ_{PUCCH} [dB] |
| 0 | −1 |
| 1 | 0 |
| 2 | 1 |
| 3 | 3 |

TABLE 5.1.2.1-2
Mapping of TPC Command Field in DCI format 3A to δ_{PUCCH} values.

| TPC Command Field | |
|---|---|
| in DCI format 3A | δ_{PUCCH} [dB] |
| 0 | −1 |
| 1 | 1 |

### Beam Specific Power Control

It is envisioned that NR supports beam specific power control although the exact details on what “beam specific” implies are not yet fully decided. Beam specific PC may for instance be a scheme that enables use cases where separate power control in multiple UE TX and gNB RX beam pairs are maintained. Use cases include for instance
A UE transmitting to a TRP using a certain beam switches to another beam and then consequently also switches from one PC loop to another.
A UE transmitting to a TRPs switches to another TRP and then consequently also switches from one PC loop to another.

It is expected that the beam specific power control will imply a set of PC loops as illustrated below for the case of PUSCH. Hence, there will exist a set of PC loops where each PC loop is connected to a beam.

TABLE 1
PC loops RRC configured to the UE

| PC idx | PC loop |
|---|---|
| 0 | δ_{PUSCH, c}⁰ |
| 1 | δ_{PUSCH, c}¹ |
| 2 | δ_{PUSCH, c}² |
| 3 | δ_{PUSCH, c}³ |
| 4 | δ_{PUSCH, c}⁴ |
| 5 | δ_{PUSCH, c}⁵ |
| 6 | δ_{PUSCH, c}⁶ |

The UL PC loop can in this case be written as

P_{PUSCH,c}^{k}=min{P_{CMAX,c}^{k}−P_{PUCCH}^{J},P_{0,PUSCH}^{k}+αₖPL_{c}^{k}+10 log₁₀Mₖ+∇_{MCS}^{k}+f(i)ₖ}.

Here the meaning of αₖ, P_{0,PUSCH}^{k} etc. is that these parameters may be configured in a beam specific manner and may thus depend on k. They may however also be shared such that for instance α₀=α₁= . . . =α₆=α meaning that only α needs to be configured. The index J in P_{PUCCH}^{J} refers to the beam used for PUCCH transmission.

Furthermore, PL_{c}^{k} implies that the path loss estimation is based on a certain reference signal defined for PC loop k. Hence, each time the reference signal corresponding to PC loop k is transmitted it may be used by the UE in order to estimate PL_{c}^{k}, which is typically done by performing a long term averaging as for example

PL_{c}^{k}=referenceSignalPower−higher_layer_filtered_RSRP_k

where referenceSignalPower is defined by the network.

Finally it is pointed out that for a beam currently not used for PUSCH, hence M=0, the equation may instead be defined as P_{PUSCH,c}^{k}=min{P_{CMAX,c}^{k}−P_{PUCCH}^{J},P_{0,PUSCH}^{k}+αₖPL_{c}^{k}+f(i)ₖ}.

### SUMMARY

There currently exist certain challenge(s). In general, there is a problem with closed-loop PC in NR since new features introduced in NR may imply that situations occur when a TPC has not been transmitted by the network in a long while. Examples include
In case that an aperiodic SRS has not been triggered and transmitted in a long while this may imply that the closed loop part is outdated and it would hence be beneficial to reset the closed-loop part (in case of aggregated mode) instead of using the outdated aggregated value. On the other hand, if the SRS has been transmitted recently it would be preferable not to reset the closed-loop part.
The same problem occurs in beam-specific PC when the gNB redirects its beam; in this case to closed loop PC part of the beam corresponding to the old direction may be irrelevant for the new propagation environment in case of aggregated mode. Hence, also here it would be beneficial to reset the closed PC loop part at selected occasions.
Furthermore, if multiple closed loops are supported in the case of beam-specific power control, the situation when a beam has not been used for PUSCH for a long time implies that the closed loop part may be outdated since TPC will be applied to the PC loops used for PUSCH transmissions. Hence, also here a motivation may exist to reset the closed loop PC part.

In summary, there is a need to provide a mechanism for resetting the closed PC part.

Certain aspects of the present disclosure and their embodiments may provide solutions to these or other challenges.

One aspect of the disclosure provides a method performed by a wireless device for transmit power control. The wireless device is operable in a wireless telecommunications network, and is configured to determine a value for its transmit power based at least in part on cumulative transmit power control, whereby the wireless device determines a value for a cumulative transmit power control function based on a previous value for the cumulative transmit power control function and a correction value. The method comprises receiving, from a network node operable in the wireless telecommunications network, a control signal comprising an indication of a correction value, wherein the indication of the correction value has one of a plurality of possible values. The method further comprises responsive to a determination that the indication of the correction value is a particular value of the plurality of possible values, resetting the cumulative transmit power control.

Another aspect provides a method performed by a network node operable in a wireless telecommunications network, for transmit power control of a wireless device operable in the wireless telecommunications network. The wireless device is configured to determine a value for its transmit power based at least in part on cumulative transmit power control, whereby the wireless device determines a value for a cumulative transmit power control function based on a previous value for the cumulative transmit power control function and a correction value. The method comprises selecting, from a plurality of possible values, a value for an indication of a correction value, the plurality of possible values comprising a particular value mappable by the wireless device to an instruction to reset the cumulative transmit power control. The method further comprises initiating transmission of the selected value for the indication of the correction value to the wireless device.

For example, one aspect proposes a reset option in the available δ_{PUSCH,c} and/or δ_{PUCCH} values. Hence, one option that could be indicated with TPC would be to signal “reset”. The signalling of “reset” may be explicit.

In a further aspect, it may be configurable whether this “reset” value exists or not. In one such example, for transmissions of a periodic nature, such as a periodically transmitted SRS, the network utilizes the full range of δ_{PUSCH,c} and/or δ_{PUCCH}. For an aperiodic SRS, it may however be more beneficial to have the ability to reset the closed part PC loop than to have the full range of δ_{PUSCH,c} and/or δ_{PUCCH} available. Hence, here we could configure one of the available values of δ_{PUSCH,c} and/or δ_{PUCCH} to represent “reset”.

Further embodiments of the disclosure provide a UE that interprets one particular value of the TPC command field as a reset command for the closed loop part of the UL PC framework.

The UE may support configurability so that said particular value can represent reset but also something else, depending on configuration.

The configuration of the particular value may be implemented per PC loop (or process). Different PC loops may represent different beams, which hence can be configured differently.

There are, proposed herein, various embodiments which address one or more of the issues disclosed herein.

Embodiments may provide one or more of the following technical advantage(s). Embodiments may enable dynamic reset of a cumulative transmit power control, and thereby optimisation of the transmit power of a wireless device. For example, certain embodiments may support explicit reset signaling of the closed loop PC part, without increasing the size of TPC signaling. Instead one sacrifices some of the resolution of δ_{PUSCH,c} and/or δ_{PUCCH}.

### DESCRIPTION OF THE FIGURES

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

FIG. 1 shows a wireless network in accordance with embodiments;

FIG. 2 shows a user equipment in accordance with embodiments;

FIG. 3 shows a virtualization environment in accordance with some embodiments;

FIG. 4 shows a telecommunication network connected via an intermediate network to a host computer in accordance with some embodiments;

FIG. 5 shows a host computer communicating via a base station with a user equipment over a partially wireless connection in accordance with some embodiments;

FIG. 6 shows methods implemented in a communication system including a host computer, a base station and a user equipment in accordance with some embodiments;

FIG. 7 shows method implemented in a communication system including a host computer, a base station and a user equipment in accordance with some embodiments;

FIG. 8 is flow diagram showing a method in accordance with some embodiments;

FIG. 9 shows virtualisation apparatus in accordance with some embodiments;

FIG. 10 is a flow diagrams showing a method in accordance with some embodiments; and

FIG. 11 shows virtualisation apparatus in accordance with some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

One aspect of the disclosure relates to transmit power control (TPC), and particularly the control of the transmit power of a wireless device or UE in a wireless communications network. The wireless device may be configured to determine its transmit power based at least in part on a cumulative transmit power control function (e.g. f(i) or g(i) discussed above). Thus, in such a configuration, the wireless device may determine a value for the cumulative transmit power control function based on a previous value for the cumulative transmit power control function and a correction value received from the network (e.g. from a base station or network node). The correction value may define an adjustment to the previous value for the cumulative transmit power control function (defined as an absolute adjustment or a proportional adjustment, e.g. dBs). The correction value may also be referred to as an adjustment value or an offset value.

The cumulative transmit power control function may represent a closed-loop part of an overall transmit power control. Thus, the correction value may be determined in the network based on measurement(s) performed on reference signals transmitted by the wireless device and received by a network node. If the measurements indicate a decrease in a wireless quality or power parameter (e.g. received signal received quality, received signal received power, etc), a positive correction value may be selected in order to apply a positive effect to the determination of transmit power (and so reduce the likelihood of errors in the reception of transmissions from the wireless device, or otherwise increase the data rate of transmissions from the wireless device). If the measurements indicate an increase in a wireless quality of power parameter (e.g. above some acceptable threshold), a negative correction value may be selected in order to apply a negative effect to the determination of transmit power (and so save energy in the wireless device). The selected correction value may be signalled to the wireless device in a TPC command (e.g. using a MAC control element, or in downlink control information (DCI)).

Transmit power control may be applied to all transmissions by the wireless device or only certain transmissions by the wireless device. Further, different transmit power control processes (or loops) may be implemented or configured, to enable transmit power to be determined in a granular fashion. For example, different transmit power control processes may be implemented for transmissions over different physical channels. A first transmit power control process may be implemented for transmissions of user plane data over a physical shared channel (e.g. PUSCH), while a second transmit power control process may be implemented for transmissions of control plane data over a physical control channel (e.g. PUCCH).

The transmit power may be further determined based on an open-loop power control mechanism. For example, the wireless device may be configured to determine the transmit power based on the cumulative transmit power control function and an estimate of the pathloss between the wireless device and the network node. The latter may be estimated in the wireless device by performing measurements on reference signals received from the network node. Those skilled in the art will appreciate that yet further parameters and mechanisms may be utilized in the determination of the transmit power, in addition to the closed-loop cumulative transmit power control function and, possibly, the open-loop estimate of pathloss.

As noted above, in some scenarios it may be beneficial for the network to be able to reset the cumulative transmit power control function calculated in the wireless device. The range of possible values for the correction value is limited, and thus the ability to change the cumulative transmit power control function quickly is also limited. If the network has reason to believe that the cumulative transmit power control function is outdated, it may be more beneficial to reset the function and apply future correction values to a new value for the cumulative transmit power control function (e.g. a default value).

According to embodiments of the disclosure, a reset command may be provided by configuring the wireless device to interpret at least one value of the range of possible values for the correction value as an instruction to reset the cumulative transmit power control function. Thus, upon receiving a control signal comprising an indication of a correction value (e.g. an index value such as the TPC command field), and upon a determination that the indication takes a particular value, the wireless device may reset the cumulative transmit power control function. As noted above, resetting the transmit power control function may comprise setting the transmit power control function to a default value (e.g. 0), or otherwise setting the transmit power control function to a value which is independent of a preceding value of the transmit power control function. For example, a default process (e.g. one specified in a telecommunications standard implemented by the wireless device) may be used to determine such a value.

In one embodiment the values for the indication of the correction value and the corresponding correction values or actions are defined in a table or mapping. The table or mapping may be hard-coded in the wireless device (i.e. defined in a standard implemented by the wireless device and not subject to change or configuration), or configurable in one or more ways that are discussed in greater detail below. Thus, the wireless device receives an indication of the correction value in a transmission from the network node, and is then able to map that indication to a corresponding correction value or action.

One example of such a table is set out below, where one value for the TPC Command field (e.g. TPC_command_field=3) corresponds to a reset operation of the cumulative transmit power control function. The remaining values define different correction values to be applied to the cumulative transmit power control function. Hence, f(i) may for instance be set to zero if a reset is indicated (i.e. if TPC_command_field=3). Thus, by utilizing TPC signaling the closed loop part of PC may be reset without additional modifications to the DCI and/or MAC CE signaling. It will be understood that although the table is defined for transmit power control of PUSCH, such a table may be applied for transmit power control of any channel, such as shared channels (e.g. PUSCH) and control channels (e.g. PUCCH).

| TPC | Accumulated |
|---|---|
| Command | δ_{PUSCH, c} |
| Field | [dB] |
| 0 | −1 |
| 1 | 0 |
| 2 | 1 |
| 3 | RESET |

In another embodiment, the particular value may be configurable to represent one of a range of different actions. For example, the particular value may be configurable to represent an instruction to reset the cumulative transmit power control function, or a correction value to the cumulative transmit power control function. One example of this is shown below, where the table is modified by letting TPC_command_field=3 correspond to a value X. X may be configured to represent a correction value (e.g. X=3) or reset. Hence, by controlling this configuration the system may be optimized for maximal resolution in δ_{PUSCH,c} (i.e. by choosing the correction value, X=3) or to instead enable the reset option (i.e. by choosing X=RESET). The wireless device may be configured by dedicated (i.e. unicast, such as via RRC signalling) or broadcast (e.g. by system information or beam-specific control signals) signalling from the network node.

| TPC | Accumulated |
|---|---|
| Command | δ_{PUSCH, c} |
| Field | [dB] |
| 0 | −1 |
| 1 | 0 |
| 2 | 1 |
| 3 | X |

In a further embodiment the table may be implemented in a beam-specific or process-specific manner. Thus, respective tables may be implemented for each respective beam or transmit power control process (e.g. where separate processes may be implemented for transmissions over different physical channels, or to different network nodes, or via different beams etc). It will further be noted that respective tables may be implemented for a group of beams (i.e. one or more beams) or a group of processes (i.e. one or more processes). Alternatively, only the configuration of the particular value (e.g. TPC_command_field=3 in the example) may be implemented in such a beam-specific or process-specific manner. Thus, the remainder of the values for the indication of the correction value may take values that do not alter as between different beams or processes, while the particular value may be configured differently between different beams or processes, or between different groups of beams or processes. Again, the wireless device may be configured by dedicated (i.e. unicast, such as via RRC signalling) or broadcast (e.g. by system information or beam-specific control signals) signalling from the network node.

The table below shows an example of this, whereby TPC_command_field=3 corresponds to a value Xₖ that can be configured to Xₖ=3 or Xₖ=RESET for the kth beam or process (in the illustrated example; other correction values are possible). Thus Xₖ₁=3 may be configured for one beam or process k1, while Xₖ₂=RESET is configured for beam or process k2. In this example, therefore, it is possible to reset beam k2 whereas it is not possible to reset beam k1.

| TPC | Accumulated |
|---|---|
| Command | δ_{PUSCH, c, k} |
| Field | [dB] |
| 0 | −1 |
| 1 | 0 |
| 2 | 1 |
| 3 | Xₖ |

The Figures and description below provide further detail concerning embodiments of the disclosure, as well as the device structure and network architecture for implementing those embodiments.

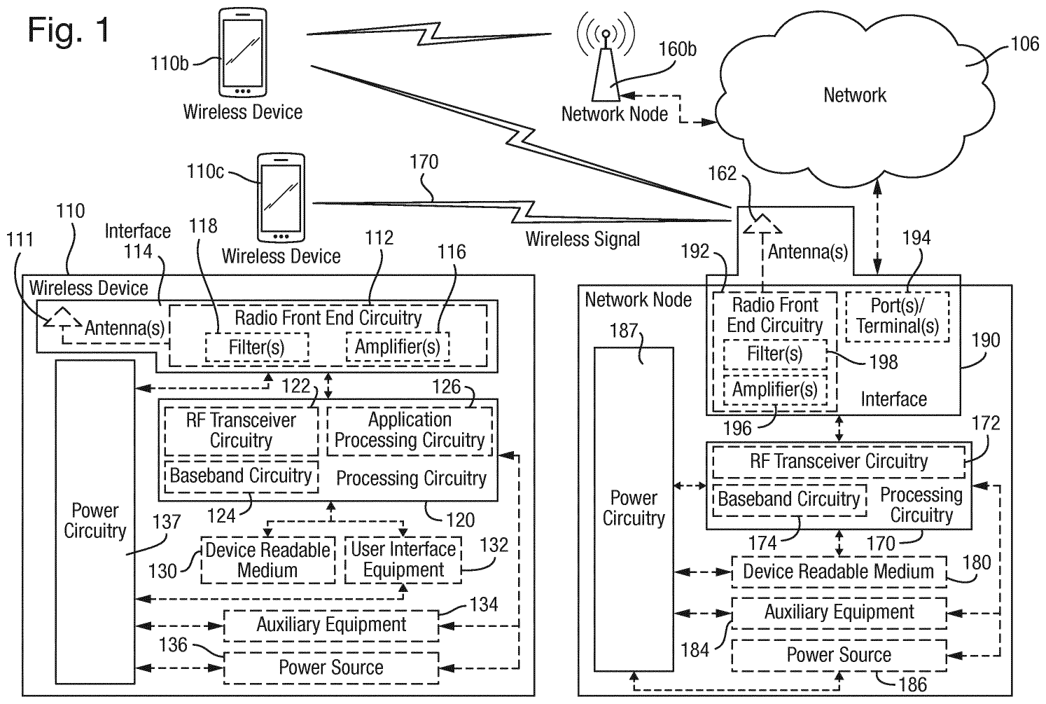

Although the subject matter described herein may be implemented in any appropriate type of system using any suitable components, the embodiments disclosed herein are described in relation to a wireless network, such as the example wireless network illustrated in FIG. 1. For simplicity, the wireless network of FIG. 1 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

Those skilled in the art will appreciate that network node 160 may be configured to provide a plurality of directional beams (e.g. using beamforming techniques) for the transmission of wireless signals (e.g. to WD 110) and the reception of wireless signals (e.g. from WD 110). Each beam may be associated with a respective beam identifier to enable it to be distinguished from neighbouring beams. Thus beam-specific signals such as beam-specific reference signals may be transmitted using each beam to enable WD 110 to determine the most-appropriate beam for communication with the network node 160. Likewise, WD 110 may be configured to transmit wireless signals (e.g. to network node 160) and receive wireless signals (e.g. from network node 160) using one or more of a plurality of directional beams. Communications between the WD 110 and the network node 160 may therefore take place via a “beam pair”, i.e. one beam generated using beamforming techniques in the WD 110, and another beam generated using beamforming techniques in the network node 160.

In FIG. 1, network node 160 includes processing circuitry 170, device readable medium 180, interface 190, auxiliary equipment 184, power source 186, power circuitry 187, and antenna 162. Although network node 160 illustrated in the example wireless network of FIG. 1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 1 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

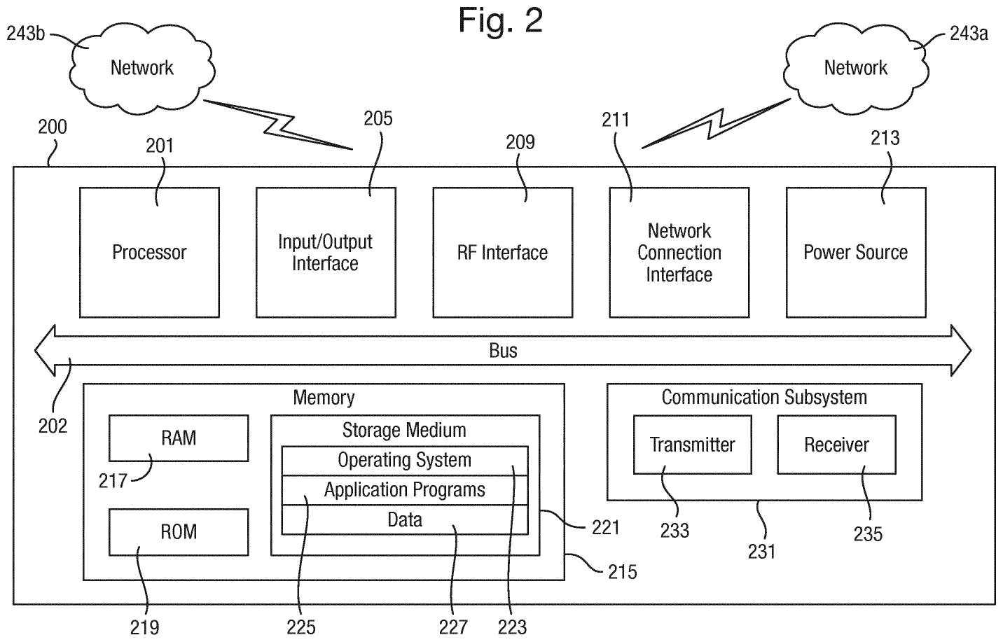

FIG. 2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 2, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 2 is a UE, the components discussed herein are equally applicable to a WD, and vice-versa.

In FIG. 2, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 2, or only a subset of the components. The level of integration between the components may vary from one UE to another UE. Further, certain UEs may contain multiple instances of a component, such as multiple processors, memories, transceivers, transmitters, receivers, etc.

In FIG. 2, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 2, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 2, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

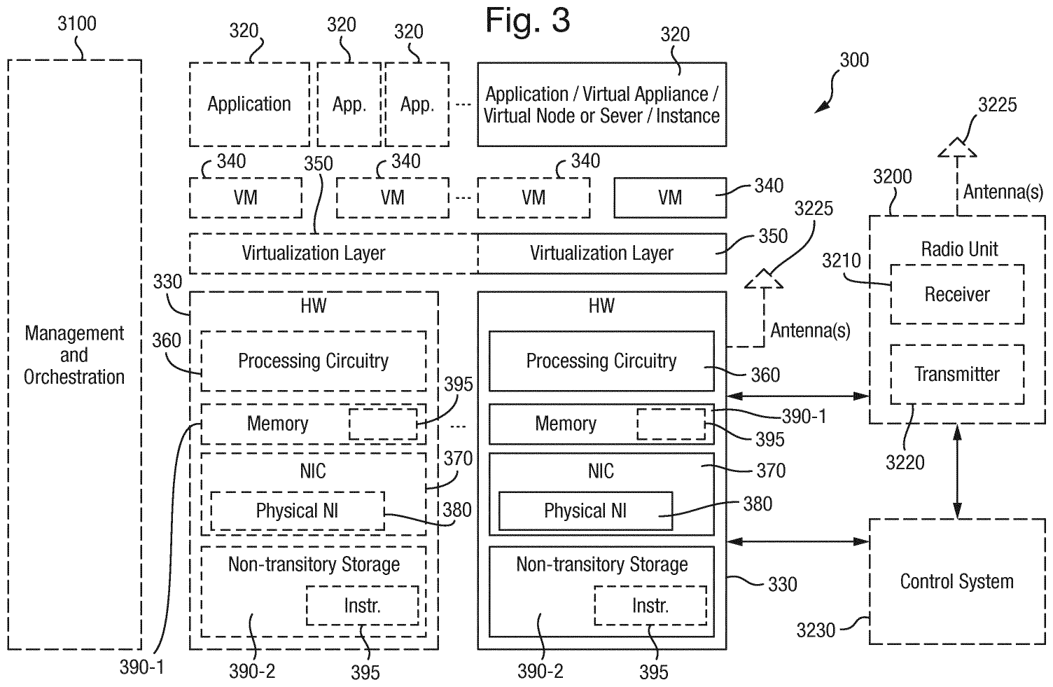

FIG. 3 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 3, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 3.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

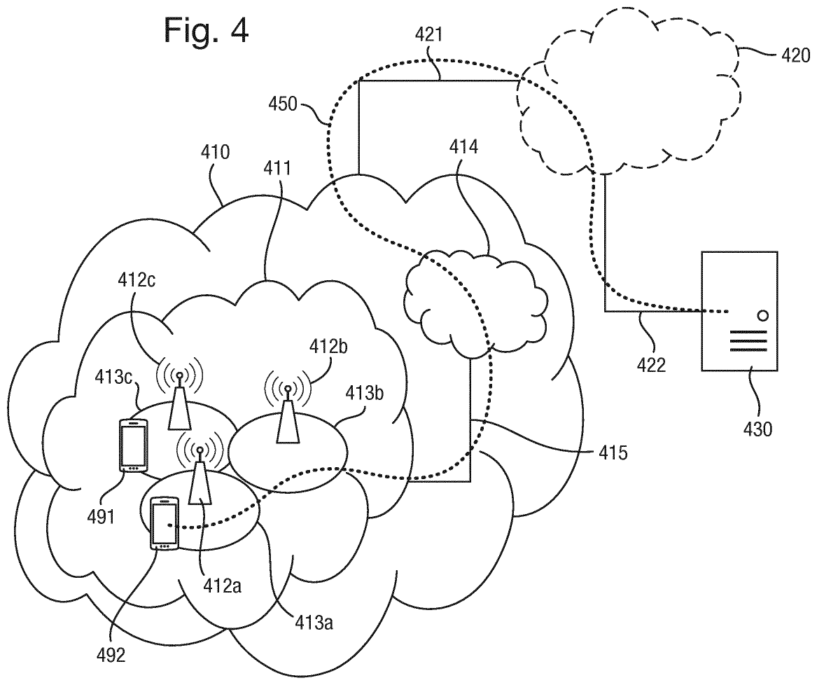

With reference to FIG. 4, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 4 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

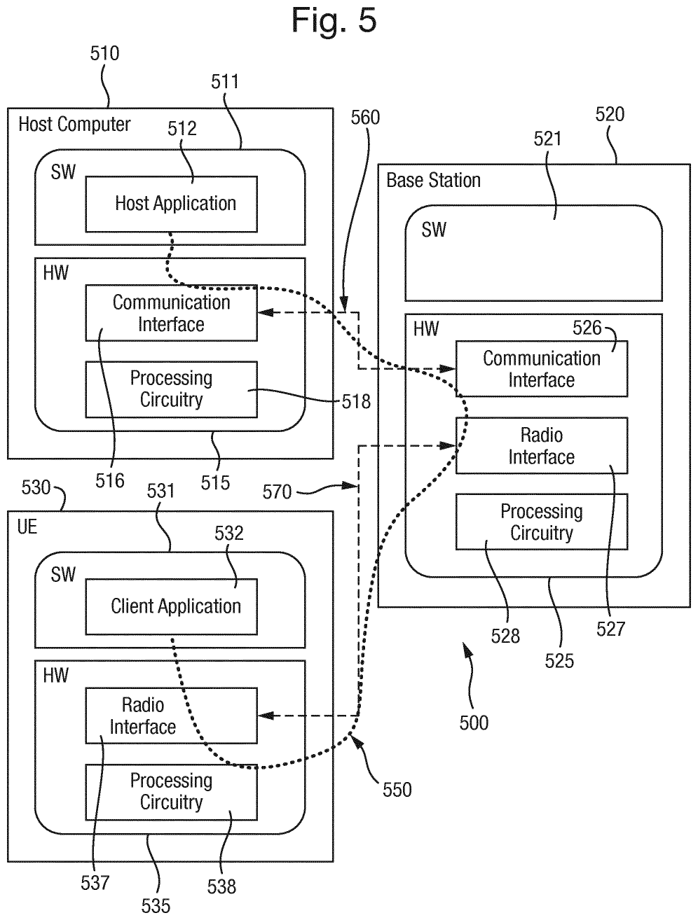

Example implementations, in accordance with an embodiment, of the UE, base station and host computer discussed in the preceding paragraphs will now be described with reference to FIG. 5. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 5) served by base station 520. Communication interface 526 may be configured to facilitate connection 560 to host computer 510. Connection 560 may be direct or it may pass through a core network (not shown in FIG. 5) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 5 may be similar or identical to host computer 430, one of base stations 412a, 412b, 412c and one of UEs 491, 492 of FIG. 4, respectively. This is to say, the inner workings of these entities may be as shown in FIG. 5 and independently, the surrounding network topology may be that of FIG. 4.

In FIG. 5, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the capacity, coverage and system robustness, and reduce power consumption and thereby provide benefits such as better responsiveness from the network and extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

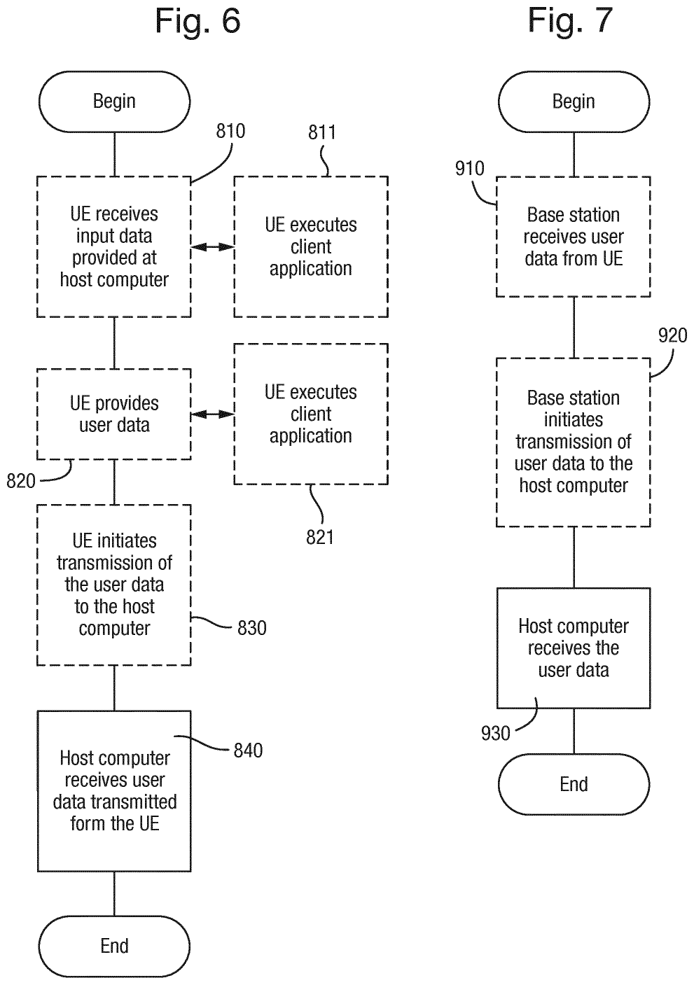

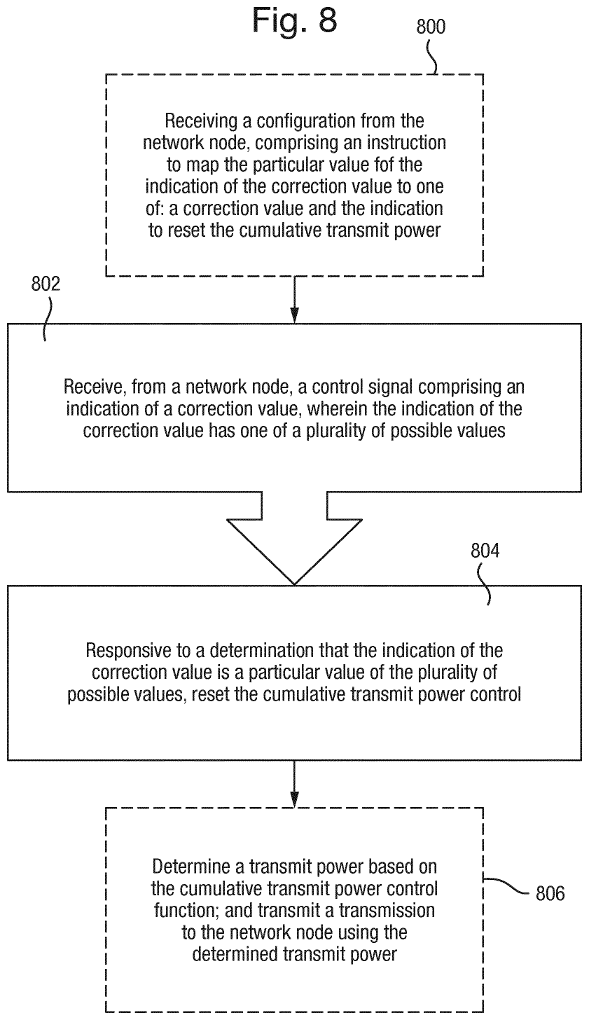

FIG. 6 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 8 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 7 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 7 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

FIG. 8 depicts a method in accordance with particular embodiments. The method may be carried out in a wireless device operable in a wireless telecommunications network (such as the wireless device 110 or the UE 200 described above). The wireless device may be configured to determine a value for its transmit power based at least in part on cumulative transmit power control, whereby the wireless device determines a value for a cumulative transmit power control function based on a previous value for the cumulative transmit power control function and a correction value.

The method begins in step 802, where the wireless device receives, from a network node operable in the wireless telecommunications network, a control signal comprising an indication of a correction value, wherein the indication of the correction value has one of a plurality of possible values.

In a subsequent step 804, the wireless device resets the cumulative transmit power control responsive to a determination that the indication of the correction value is a particular value of the plurality of possible values.

The cumulative transmit power control may be reset such that the cumulative transmit power control function of the wireless device is determined by a default process. For example, the default process may be independent of the previous value for the cumulative transmit power control function. Alternatively, the cumulative transmit power control may be reset such that the cumulative transmit power control function has a default value (e.g. 0).

The wireless device may be configured with a mapping between the plurality of possible values for the indication of the correction value, and corresponding values for the correction value and/or actions to be carried out by the wireless device. Such a mapping or table may be configured via signalling from the network node (e.g. RRC signalling). For example, the wireless device may be configured with the mapping prior to step 802. The mapping may map the particular value for the indication of the correction value to an indication to reset the cumulative transmit power control.

The particular value for the indication of the correction value may be configurable to map to one of: a correction value and an indication to reset the cumulative transmit power control. Thus, the network node may configure the cumulative transmit power control function to be resettable or not, via the particular value. Again, the configuration may be signalled from the network node (e.g. RRC signalling). Thus the method may further comprise at step 800 receiving a configuration from the network node, comprising an instruction to map the particular value for the indication of the correction value to one of: a correction value and the indication to reset the cumulative transmit power control. For example, the wireless device may be configured prior to step 802.

The wireless device may be configured to determine its transmit power based further on an estimate of the pathloss between the wireless device and the network node (i.e. an open-loop TPC mechanism).

The transmit power control may be implemented separately for different transmit power control processes and/or different beams transmitted by the network node. Thus, separate control signals or indications of correction values may be received for one or more TPC processes or one or more beams. Additionally or alternatively, respective configurations of the mapping between indications (e.g. TCP command values) and correction values or actions may be implemented for one or more TPC processes or one or more beams. Additionally or alternatively, respective configurations of the particular value (i.e. the value configurable to indicate reset) may be implemented for one or more TPC processes or one or more beams.

The method may comprise: receiving, from the network node, respective control signals for each of a plurality of directional beams transmitted by the network node; and determining respective transmit powers for each of the plurality of directional beams. Each respective control signal may comprise a respective indication of a correction value for the respective directional beam. The method may further comprise: for each directional beam, receiving a respective configuration from the network node, comprising an instruction to map the particular value for the indication of the correction value to one of: a correction value and the indication to reset the cumulative transmit power control. The method may further comprise: receiving, from the network node, respective control signals for each of a plurality of transmit power control processes; and determining respective transmit powers for each of the plurality of transmit power control processes. Each respective control signal may comprise a respective indication of a correction value for the respective transmit power control process. The method may further comprise for each transmit power control process, receiving a respective configuration from the network node, comprising an instruction to map the particular value for the indication of the correction value to one of: a correction value and the indication to reset the cumulative transmit power control.

The method may further comprise at step 806 determining a transmit power based on the cumulative transmit power control function, and transmitting a transmission to the network node using the determined transmit power.

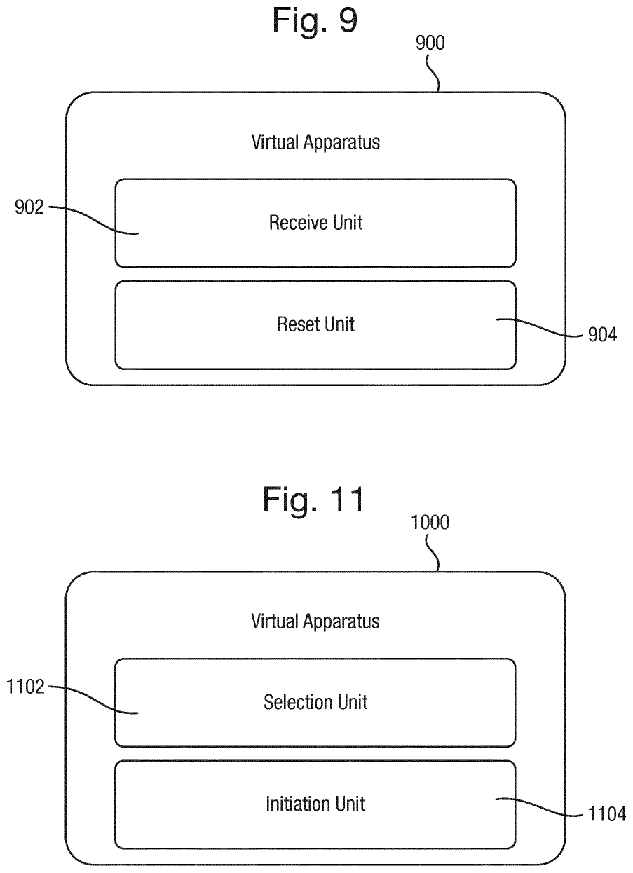

FIG. 9 illustrates a schematic block diagram of an apparatus 900 in a wireless network (for example, the wireless network shown in FIG. 1). The apparatus may be implemented in a wireless device or network node (e.g., wireless device 110 or network node 160 shown in FIG. 1). Apparatus 900 is operable to carry out the example method described with reference to FIG. 8 and possibly any other processes or methods disclosed herein. It is also to be understood that the method of FIG. 8 is not necessarily carried out solely by apparatus 900. At least some operations of the method can be performed by one or more other entities.

Virtual Apparatus 900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Receive unit 902 and Reset unit 904, and any other suitable units of apparatus 900 to perform corresponding functions according to one or more embodiments of the present disclosure.

As illustrated in FIG. 9, apparatus 900 includes receive unit 902 and reset unit 904. Receive unit 902 is configured to receive, from a network node operable in the wireless telecommunications network, a control signal comprising an indication of a correction value, wherein the indication of the correction value has one of a plurality of possible values. Reset unit 904 is configured to reset the cumulative transmit power control responsive to a determination that the indication of the correction value is a particular value of the plurality of possible values.

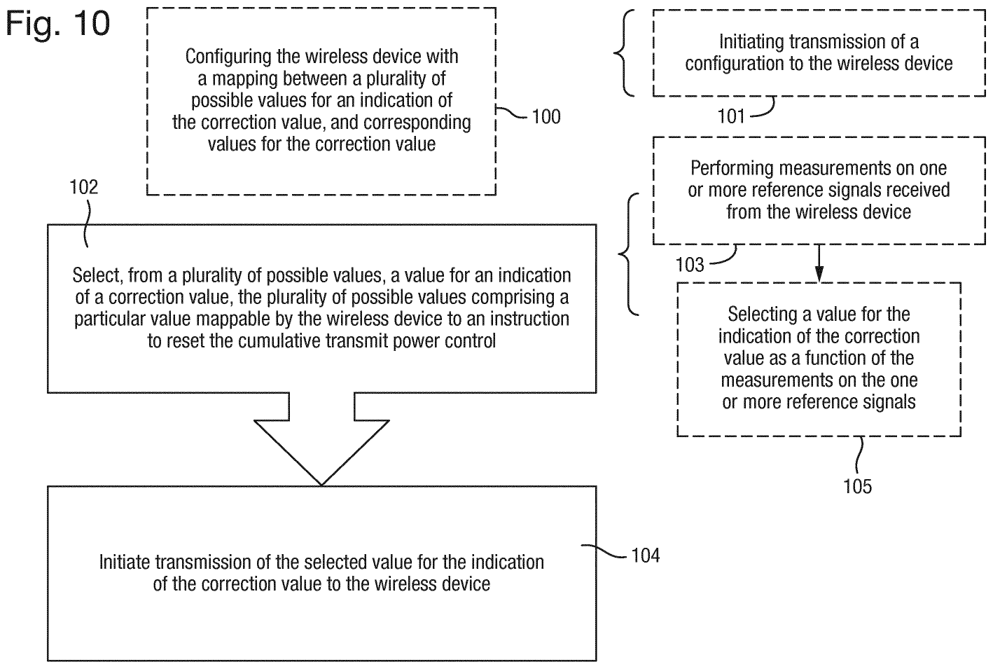

FIG. 10 depicts a method in accordance with some embodiments. The method may be carried out in a network node operable in a wireless telecommunications network (such as the network node 160 described above). The method relates to transmit power control of a wireless device operable in the wireless telecommunications network (such as the WD 110 or the UE 200 described above). The wireless device may be configured to determine a value for its transmit power based at least in part on cumulative transmit power control, whereby the wireless device determines a value for a cumulative transmit power control function based on a previous value for the cumulative transmit power control function and a correction value.

The method begins in step 102, where the network node selects, from a plurality of possible values, a value for an indication of a correction value, the plurality of possible values comprising a particular value mappable by the wireless device to an instruction to reset the cumulative transmit power control.

In a subsequent step 104, the network node initiates transmission of the selected value for the indication of the correction value to the wireless device.

The selected value may be the particular value mappable by the wireless device to an instruction to reset the cumulative transmit power control.

The method may further comprise the step 103 of performing measurements on one or more reference signals received from the wireless device. For example, suitable reference signals may include SRSs transmitted by the wireless device. The value for the indication of the correction value may then comprise at step 105 selecting a value as a function of the measurements on the one or more reference signals.

The cumulative transmit power control may be reset in the wireless device such that the cumulative transmit power control function of the wireless device is determined by a default process. For example, the default process may be independent of the previous value for the cumulative transmit power control function. Alternatively, the cumulative transmit power control may be reset such that the cumulative transmit power control function has a default value (e.g. 0).

The network node may at step 100 configure the wireless device with a mapping between the plurality of possible values for the indication of the correction value, and corresponding values for the correction value and/or actions to be carried out by the wireless device. Such a mapping or table may be configured via signalling from the network node (e.g. RRC signalling). For example, the wireless device may be configured with the mapping prior to step 102. The mapping may map the particular value for the indication of the correction value to an indication to reset the cumulative transmit power control.

The particular value for the indication of the correction value may be configurable to map to one of: a correction value and an indication to reset the cumulative transmit power control. Thus, the network node may configure the cumulative transmit power control function to be resettable or not, via the particular value. Again, the configuration may be signalled from the network node (e.g. RRC signalling). Thus the method may further comprise at step 101 initiating transmission of a configuration to the wireless device, comprising an instruction to map the particular value for the indication of the correction value to one of: a correction value and the indication to reset the cumulative transmit power control. For example, the wireless device may be configured prior to step 102. The configuration of the interpretation in the wireless device of the particular value may be dependent on one or more parameters associated with reference signals transmitted by the wireless device and used by the network node to select a correction value for the cumulative transmit power control function. For example, the configuration may depend on whether the reference signals are transmitted by the wireless device periodically or aperiodically. In the former case, the network node may configure the wireless device to map the particular value to a correction value; in the latter case, the network node may configure the wireless device to map the particular value to an instruction to reset the cumulative transmit power control function. In other words the particular value for the indication of the correction value may be configurable to map to one of a correction value and an indication to reset the cumulative transmit power control as a function of the one or more reference signals being transmitted by the wireless device periodically or aperiodically. The transmit power control may be implemented separately for different transmit power control processes and/or different beams transmitted by the network node. Thus, separate control signals or indications of correction values may be transmitted for one or more TPC processes or one or more beams. Additionally or alternatively, respective configurations of the mapping between indications (e.g. TCP command values) and correction values or actions may be implemented for one or more TPC processes or one or more beams. Additionally or alternatively, respective configurations of the particular value (i.e. the value configurable to indicate reset) may be implemented for one or more TPC processes or one or more beams. The method may comprise initiating transmission of respective control signals for each of a plurality of directional beams. Each respective control signal may comprise a respective indication of a correction value for the respective directional beam. The method may further comprise: for each directional beam, initiating transmission of a respective configuration to the wireless device, comprising an instruction to map the particular value for the indication of the correction value to one of: a correction value and the indication to reset the cumulative transmit power control. The method may further comprise: initiating transmission of respective control signals for each of a plurality of transmit power control processes. Each respective control signal may comprise a respective indication of a correction value for the respective transmit power control process. The method may further comprise: for each transmit power control process, initiating transmission of a respective configuration to the wireless device, comprising an instruction to map the particular value for the indication of the correction value to one of: a correction value and the indication to reset the cumulative transmit power control.

FIG. 11 illustrates a schematic block diagram of an apparatus 1100 in a wireless network (for example, the wireless network shown in FIG. 1). The apparatus may be implemented in a wireless device or network node (e.g., wireless device 110 or network node 160 shown in FIG. 1). Apparatus 1100 is operable to carry out the example method described with reference to FIG. 10 and possibly any other processes or methods disclosed herein. It is also to be understood that the method of FIG. 10 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause selection unit 1102 and initiation unit 1104, and any other suitable units of apparatus 1100 to perform corresponding functions according to one or more embodiments of the present disclosure.

As illustrated in FIG. 11, apparatus 1100 includes selection unit 1102 and initiation unit 1104. Selection unit 1102 is configured to select, from a plurality of possible values, a value for an indication of a correction value, the plurality of possible values comprising a particular value mappable by the wireless device to an instruction to reset the cumulative transmit power control. Initiation unit 1104 is configured to initiate transmission of the selected value for the indication of the correction value to the wireless device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SRS Sounding Reference Signal
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-25. (canceled)

26. A method performed by a wireless device for transmit power control, the wireless device being operable in a wireless telecommunications network, the wireless device being configured to determine a value for its transmit power based in part on cumulative transmit power control representing a closed-loop power control part of the transmit power control, whereby the wireless device determines a value for a cumulative transmit power control function based on a previous value for the cumulative transmit power control function and a correction value, the method comprising:
receiving, from a network node operable in the wireless telecommunications network, a control signal comprising an indication of a correction value, wherein the indication of the correction value has one of a plurality of possible values; and
responsive to a determination that the indication of the correction value is a particular one value of the plurality of possible values, resetting the closed-loop power control part by resetting the cumulative transmit power control function.

27. The method of claim 26, wherein the cumulative transmit power control function is reset such that the cumulative transmit power control function of the wireless device is determined by a default process.

28. The method of claim 27, wherein the default process is independent of the previous value for the cumulative transmit power control function.

29. The method of claim 26, wherein the cumulative transmit power control function is reset such that the cumulative transmit power control function has a default value.

30. The method of claim 26, wherein the wireless device is configured with a mapping between the plurality of possible values for the indication of the correction value, and corresponding values for the correction value.

31. The method of claim 26, wherein the particular one value for the indication of the correction value is configurable to map to one of: a correction value and an indication to reset the cumulative transmit power control function.

32. The method of claim 31, further comprising:
receiving a configuration from the network node, comprising an instruction to map the particular value for the indication of the correction value to one of: a correction value and the indication to reset the cumulative transmit power control function.

33. The method of claim 26, wherein the transmit power is further determined based on an estimate of the pathloss between the wireless device and the network node.

34. The method of claim 26, further comprising:
determining a transmit power based on the reset cumulative transmit power control function; and
transmitting a transmission to the network node using the determined transmit power.

35. A method performed by a network node operable in a wireless telecommunications network, for transmit power control of a wireless device operable in the wireless telecommunications network and configured to determine a value for its transmit power based in part on cumulative transmit power control representing a closed-loop power control part of the transmit power control, whereby the wireless device determines a value for a cumulative transmit power control function based on a previous value for the cumulative transmit power control function and a correction value, the method comprising:
selecting, from a plurality of possible values, a value for an indication of a correction value, the plurality of possible values comprising a particular one value indicating the wireless device is to reset the closed-loop power control part by resetting the cumulative transmit power control function; and
initiating transmission of the selected value for the indication of the correction value to the wireless device.

36. The method of claim 35, further comprising:
performing measurements on one or more reference signals received from the wireless device; and
wherein the step of selecting a value for the indication of the correction value comprises selecting a value as a function of the measurements on the one or more reference signals.

37. The method of claim 36, wherein the reference signals comprising sounding reference signals, SRS.

38. The method of claim 35, wherein the particular one value indicates the wireless device is to reset the cumulative transmit power control function such that the cumulative transmit power control function is determined by a default process independent of the previous value for the cumulative transmit power control function.

39. The method of claim 35, wherein the particular one value indicates the wireless device is to reset the cumulative transmit power control function such that the cumulative transmit power control function has a default value.

40. The method of claim 35, further comprising configuring the wireless device with a mapping between the plurality of possible values for the indication of the correction value, and corresponding values for the correction value.

41. The method of claim 35, wherein the particular value for the indication of the correction value is configurable to map to one of: a correction value and an indication to reset the cumulative transmit power control function.

42. The method of claim 41, further comprising:
performing measurements on one or more reference signals received from the wireless device; and
wherein the step of selecting a value for the indication of the correction value comprises selecting a value as a function of the measurements on the one or more reference signals, wherein the particular value for the indication of the correction value is configurable to map to one of a correction value and an indication to reset the cumulative transmit power control function as a function of the one or more reference signals being transmitted by the wireless device periodically or aperiodically.

43. The method of claim 41, further comprising:
initiating transmission of a configuration to the wireless device, comprising an instruction to map the particular one value for the indication of the correction value to one of: a correction value and the indication to reset the cumulative transmit power control function.

44. A wireless device for performing transmit power control, the wireless device being configured to determine a value for its transmit power based in part on cumulative transmit power control representing a closed-loop power control part of the transmit power control, whereby the wireless device determines a value for a cumulative transmit power control function based on a previous value for the cumulative transmit power control function and a correction value, the wireless device comprising:
processing circuitry configured to cause the wireless device to:
i. receive, from a network node operable in the wireless telecommunications network, a control signal comprising an indication of a correction value, wherein the indication of the correction value has one of a plurality of possible values; and
ii. responsive to a determination that the indication of the correction value is a particular one value of the plurality of possible values, reset the closed-loop power control part by resetting the cumulative transmit power control; and
power supply circuitry configured to supply power to the wireless device.

45. A base station for performing transmit power control of a wireless device operable in the wireless telecommunications network and configured to determine a value for its transmit power based in part on cumulative transmit power control representing a closed-loop power control part of the transmit power control, whereby the wireless device determines a value for a cumulative transmit power control function based on a previous value for the cumulative transmit power control function and a correction value, the base station comprising:
processing circuitry configured to cause the base station to:
select, from a plurality of possible values, a value for an indication of a correction value, the plurality of possible values comprising a particular one value indicating the wireless device is to reset the closed-loop power control part by resetting the cumulative transmit power control; and
initiate transmission of the selected value for the indication of the correction value to the wireless device; and
power supply circuitry configured to supply power to the base station.
